(19) United States
(12) Patent Application Publication
(10) Pub. No.: US 2014/0353243 A1
(43) Pub. Date: Dec. 4, 2014

(54) Low Soluble Iron Content Diamite Filter Aids

(71) Applicant: EP MINERALS, LLC, Reno, NV (US)

(72) Inventors: Qun Wang, Reno, NV (US); Peter Edward Lenz, Reno, NV (US); Chongjun Jiang, Reno, NV (US); Bradley Scott Humphreys, Sparks, NV (US)

(21) Appl. No.: 13/906,943

(22) Filed: May 31, 2013

(51) Int. Cl. B01D 39/20; B01J 20/14; B01J 20/30

(52) U.S. Cl. CPC B01D 39/2075; B01J 20/3078; B01J 20/14
USPC 210/510.1; 502/411

(57) ABSTRACT

A process for manufacturing low soluble iron, medium flow rate diatomite filter aids and such filter aids are disclosed. Sodium aluminate is used as an additive. As compared to either straight calcined or soda ash flux-calcined diatomite filter aids of similar permeabilities made from the same ore, the disclosed filter aids have much lower iron solubilities. For instance, disclosed filter aids of about 0.3 to about 2.0 Darcy were made using an alkali aluminate as an additive/flux agent to have an EBC soluble iron content of less than 100 ppm versus more than 140 ppm for similar filter aids that were made from the same ore and flux-calcined with soda ash.

### TECHNICAL FIELD

Disclosed herein are diatomite or diatomaceous earth filter aids with reduced soluble iron content and methods for reducing soluble iron content in diatomite or diatomaceous earth filter aids.

### BACKGROUND

Diatomite (diatomaceous earth) is a sediment that includes silica in the form of siliceous skeletons (frustules) of diatoms. Diatoms are a diverse array of microscopic, single-celled, golden-brown algae generally of the class Bacillariophyceae that possess ornate siliceous skeletons of varied and intricate structures. Because of these ornate skeletal structures, diatomite may be used as a filter aid for separating particles from fluids. The intricate and porous structures unique to diatomite can physically entrap particles during filtration processes. Diatomite can also improve the clarity of fluids that exhibit turbidity or contain suspended particles or particulate matter.

Because diatoms are water-borne, diatomite deposits are typically found at locations relating to either existing or former bodies of water. Diatomite deposits are generally divided into freshwater and saltwater categories.

When used as a filter aid, the iron in a diatomite product may become soluble in the liquid being filtered. In many applications, this increase in iron content in the fluid being filtered may be undesirable or even unacceptable. For example, when diatomite filter aids are used to filter beer, iron dissolved in the beer may adversely affect the taste and shelf-life of the beer. Thus, the brewing industry demands diatomite filter aids with a low content of iron that is soluble in beer.

The brewing industry has developed two protocols to measure the beer-soluble iron content of diatomite filter aids. In the European Brewing Convention (EBC) protocol, a 1% potassium hydrogen phthalate solution is contacted with the filter aid for two hours before the iron content of the solution is measured. In the American Society of Brewing Chemists (ASBC) protocol, a sample of beer is contacted with the filter aid for nine minutes and then the resulting iron content in the beer is measured.

Many methods have been developed to reduce the soluble iron content in diatomite filter aids. One such method is diatomite ore selection; some diatomite ores naturally contain less iron than other ores. Some other ores may contain relatively high iron content but, due to the overall ore chemistry, diatomite filter aids made from these ores may still have lower soluble iron content. Ore selection alone, however, may not be sufficient to supply the brewing and other industries with required low soluble iron content diatomite filter aids.

Another method known to change soluble iron content in diatomaceous earth is the process of calcination. Calcination generally involves heating diatomite at a high temperature, for example, in excess of 900° C. (1652° F.). There are two types of calcination processes that are commonly practiced in the diatomite industry: straight calcination and flux-calcination.

Straight calcination does not involve the addition of a fluxing agent, and straight calcination usually reduces the presence of organics and volatiles in diatomite. Straight calcination also induces a color change from off-white to tan or pink. Straight calcination is commonly used to produce filter aids of low to medium permeability up to 0.7 Darcy. Straight calcination usually causes diatomite surface dehydration that is often accompanied by an increased soluble iron content in the calcined product. On the other hand, during calcination, the surface area of diatomite particles is reduced due to sintering and agglomeration. Surface area reduction reduces the soluble iron content because some of the iron in the diatomite product becomes inaccessible from the particulate surfaces in contact with the liquid to be filtered. Still further, the calcination temperature and/or degree of calcination will also impact the soluble iron content.

For example, straight calcined conventional diatomite filter aids made from certain ores near the higher end of their permeability range (0.3-0.7 Darcy) have a reduced soluble iron content, as the effects of the surface area reduction tends to dominate over the effects of surface dehydration. In contrast, with some other diatomite ores, the soluble iron content increases with the degree of calcination until it becomes over-calcined, resulting in severely reduced surface area and porosity and increased wet bulk density thus rendering the product ineffective as a filter aid. As a result, straight calcined diatomite filter aids of 0.3-0.7 Darcy permeability made from these ores have a higher soluble iron content, sometimes over 100 ppm as determined by the EBC method.

Diatomite may also be calcined with an alkali flux agent such as sodium carbonate (soda ash) or sodium chloride to make filter aids with permeabilities in the range of 0.5 to 10 Darcy. When diatomite is flux-calcined with sodium-based fluxing agents at moderate temperatures to produce filter aids with permeabilities in the range from 0.5 to 2 Darcy, the filter aids often have higher soluble iron contents than straight calcined filter aids because the silica matrix is partially converted to a more soluble alkali silicate thereby increasing the iron solubility. The calcination temperature is also relevant; a diatomite filter aid that is flux-calcined at higher temperatures and that has permeability of higher than 2 Darcy generally has a lower soluble iron content than a filter aid calcined at more moderate or lower temperatures due to the reduction in the effective surface area.

In summary, flux-calcined diatomite filter aids having permeabilities in the range of 0.5 to 2 Darcy are difficult grades to manufacture in terms of iron solubility control. Further, to control the permeability or keep it in a low to moderate range, calcination usually has to be carried out at relatively lower temperatures, which prevents both a significant reduction of the surface area and a partial reversal of the increased soluble iron content caused by the common fluxing agents. Regardless, the net effect is an increase in the soluble iron content.

The soluble iron content of a diatomite filter aid may naturally decrease with time after calcination. Surface re-hydration by humidity in ambient air, for example, is one natural mechanism of soluble iron reduction by the aging process. Achieving soluble iron content reduction naturally, however, may take months, and the results may fluctuate with the seasons and the selection of diatomite ore.

Hydration or water treatment at higher temperatures is known to accelerate the soluble iron reduction process. Typical hydration treatment may include spraying a diatomite filter aid with water and mixing the water with the filter aid while the filter aid is still hot, e.g., at temperatures ranging from about 60° C. (140° F.) to about 95° C. (203° F.). The treated filter aid may be held in containers, such as bins and rail cars, until the soluble iron content is reduced to the desired level. Hydration treatments may also include the use of steam and/or be done at a temperature higher than 100° C. (212° F.) in a pressurized vessel, as described in U.S. Pat. No. 7,767,621.

However, hydration treatment may not be effective for certain diatomaceous filter aids that have relatively high soluble iron contents. Further, more intensified hydration treatments may not be cost effective. Hydration treatments are usually less effective for flux-calcined diatomite filter aids of medium permeabilities.

Chemicals may also be applied to filter aids to reduce the soluble iron content. Chemical processes include, for example, acid washing, as described in U.S. Pat. No. 5,656,568, as part of the process of making high purity diatomite filter aids. Leaching with chelating solutions such as ethylenediaminetetraacetic acid (EDTA) or citric acid is also practiced. Although such methods can be somewhat effective in reducing the soluble metal content, such processes are usually expensive and cannot be used for conventional filter aid manufacturing. Another chemical treatment for soluble iron content reduction is described in U.S. Pat. No. 5,009,906, in which an alkali metal silicate solution is applied to a diatomite filter aid to reduce the content of soluble multivalent metals such as iron and aluminum. Yet another chemical treatment for soluble metal content reduction is described in U.S. Patent Application No. 2011/0174732 in which a metal blocking agent such as a phosphorous containing chemical such as an alkali (poly)phosphate is used to pretreat diatomite prior to calcination.

U.S. Patent Application No. 2010/0195168 discloses the use of at least one alkali or alkaline earth metal aluminate to make low crystalline silica diatomite filter aids of less than 1% cristobalite. The patent application discloses diatomite filter aids containing at least one alkali or alkaline earth metal aluminate and less than 1% cristobalite. The patent application also discloses the process of making such low crystalline silica diatomite filter aids using at least one alkali or alkali earth metal aluminate by calcination at a temperature less than 900° C. This low calcination temperature is necessary to prevent a significant amount of cristobalite from forming.

Therefore, a need exists for effective processes to produce diatomite filter aids with low soluble iron content, especially in the medium permeability range from about 0.3 to about 2 Darcy and especially from ores that usually produce filter aid products of higher soluble iron content.

### SUMMARY

In one aspect, a diatomite filter aid is disclosed that comprises at least one alkali aluminate, a European Brewing Convention (EBC) soluble iron content of less than about 100 ppm or an American Society of Brewing Chemists (ASBC) soluble iron content of less than about 50 ppm. The disclosed diatomite filter aid has a cristobalite content exceeding 1 wt %, and a permeability ranging from about 0.3 to about 2 Darcy. In a refinement, the filter aid may have a permeability ranging from about 0.5 to about 1.5 Darcy. In another refinement, the filter aid has cristobalite content of greater than about 2%.

In another aspect, a method for preparing a diatomite filter aid is disclosed that may include mixing at least one alkali metal aluminate with diatomite to form a mixture and calcining the mixture at a temperature ranging from 900° C. to about 1300° C. to produce a filter aid product having an EBC soluble iron content of less than about 100 ppm or an ASBC soluble iron content of less than about 50 ppm. In a refinement, the filter aid product may have a permeability ranging from about 0.3 to about 2 Darcy. In a refinement, the mixture may include a diatomite fluxing agent selected from the group consisting of an alkali metal carbonate, halide, and combinations thereof.

In another aspect, a method for preparing an alkali metal aluminate-added diatomite calcination feed mixture is disclosed that may include mixing at least one alkali metal aluminate with diatomite to form a first mixture, and forming the calcination feed from the first mixture. The diatomite filter aid made from the calcination feed may have an EBC soluble iron content of less than about 100 ppm or an ASBC soluble iron content of less than about 50 ppm. The method may further include drying the feed mixture before forming the calcination feed when the at least one alkali metal aluminate is provided in the form of an aqueous solution. In another refinement, the method may include fine milling of the at least one alkali metal aluminate, wherein the at least one alkali metal aluminate is solid and the diatomite is dry diatomite. In a different refinement, the method may include fine milling of the at least one alkali metal aluminate, and drying the first mixture before forming the calcination feed, wherein the at least one alkali metal aluminate is solid and the diatomite is wet diatomite. In a further refinement, the diatomite may be a wet diatomite ore before drying. In yet another refinement, the method may include co-milling of the alkali metal aluminate with a dispersion material to assist in the milling/dispersion of the former before the mixing. The dispersion material may be diatomite, rice, rice hull, perlite, saw dust, or the like. The at least one alkali metal aluminate may be solid and the alkali metal aluminate of the mixing is the result of the co-milling. In a refinement, the method may further include drying the first mixture, wherein the diatomite is wet diatomite.

In any one or more of the embodiments described above, the EBC soluble iron content may be less than 100 ppm in some embodiments, less than 70 ppm in some other embodiments, and less than 50 ppm in some other embodiments. The ASBC soluble iron content in any of the same embodiments may be less than 50 ppm, less than 35 ppm, and less than 25 ppm, respectively.

In any one or more of the embodiments described above, the filter aid may have a permeability ranging from about 0.3 to about 2 Darcy.

In any one or more of the embodiments described above, the calcining of the feed mixture may be carried out at a temperature ranging from about 900° C. to about 1300° C. In some embodiments, the calcining of the feed mixture may be carried out at a temperature ranging from above 900° C. to about 1150° C.

In any one or more of the embodiments described above, the at least one alkali metal aluminate is sodium aluminate. In some embodiments, the at least one alkali metal aluminate may be selected from the group consisting of lithium aluminate, sodium aluminate, potassium aluminate and combinations thereof. An aluminate of one of the other members of the alkali metal group or its combination with another alkali metal aluminate may also be used.

In any one or more of the embodiments described above, the at least one alkali metal aluminate is sodium aluminate which may be provided in the form of an aqueous solution, a solid of the anhydrous form, or hydrated to various degrees. The alkali metal to aluminum molar ratio in the alkali metal aluminate may vary from 0.1 to 10.

In any one or more of the embodiments described above, the calcination feed mixture may have an alkali metal aluminate content, on an anhydrous basis, in an amount ranging from about 0.1 to about 10 wt % and, in some embodiments, the mixture may have an alkali metal aluminate content, on an anhydrous basis, in an amount ranging from about 2 to about 8 wt %.

In any one or more of the embodiments described above, the calcination feed mixture may further include water.

### DESCRIPTION

As a solution to the soluble iron problem associated with making filter aids from certain difficult diatomite ores, alkali metal aluminate is disclosed as an effective additive for manufacturing diatomite filter aids with reduced soluble iron content, especially in the medium permeability range from about 0.3 Darcy to about 2 Darcy. The efficacy of alkali metal aluminate is established below, with sodium aluminate (NaAlO₂.xH₂O) being used in the examples.

The diatomite feedstock was prepared from a Nevada fresh water diatomite ore by oven drying, hammer milling and air classification. Three feedstock batches were utilized, and their particle size distributions (PSD) and chemistry properties as measured by X-ray fluorescence (XRF) are shown in Table I.

TABLE I
PSD and Major Element Chemistry of the Feed Examples - XRF (Ignited Basis)

| | PSD, μm | | | | | | | | | | | As | S |
|---|---|---|---|---|---|---|---|---|---|---|---|---|---|
| Feedstock | D10 | D50 | D90 | SiO₂ % | Al₂O₃ % | CaO % | MgO % | Na₂O % | K₂O % | Fe₂O₃ % | TiO₂ % | ppm | ppm |
| A | 7.0 | 13.3 | 26.5 | 94.59 | 2.42 | 0.61 | 0.33 | 0.27 | 0.17 | 1.39 | 0.09 | <3 | 82 |
| B | 7.0 | 13.4 | 24.4 | 95.00 | 2.24 | 0.54 | 0.30 | 0.29 | 0.15 | 1.25 | 0.08 | <3 | 128 |
| C | 7.5 | 14.4 | 28.2 | 94.01 | 2.72 | 0.63 | 0.28 | 0.37 | 0.23 | 1.50 | 0.11 | 11 | 186 |

The sodium aluminate (NaAlO₂.xH₂O) additive used in the following examples is of a technical grade and in form of flakes. The total weight loss after drying and calcination at 982° C. led to a value for “x” of about 2.0. Inductively coupled plasma (ICP) analysis revealed 21.8 wt % sodium and 21.6 wt % aluminum, a Na₂O/Al₂O₃ molar ratio of 1.2, 40 ppm iron and 60 ppm calcium. Sodium aluminate of other Na₂O/Al₂O₃ molar ratios and/or different degrees of hydration may be used as will be apparent to those skilled in the art.

Four methods were used to mix the sodium aluminate with the diatomite. Method 1 involves milling the sodium aluminate into fine powder and applying the milled sodium aluminate to a dried diatomite. Method 2 involves dissolving the sodium aluminate into an aqueous solution and mixing the solution with diatomite followed by drying. Method 3 simulates adding the milled sodium aluminate powder to a wet diatomite to create in-situ dissolution and mixing at the same time, which in practice is equivalent to injecting a milled aluminate to wet diatomite ore in the front part of a flash drying process. Method 4 is the same as Method 3 except that the sodium aluminate and diatomite are co-milled in a 1:1 ratio before Method 3 is carried out. The purpose of co-milling is to assist in dispersion and milling of sodium aluminate. Some other solid materials may be used in co-milling with an alkali aluminate; such materials may be selected from a group of powdery materials such as expanded perlite, rice, or rice hull, just to mention a few. The four methods of adding sodium aluminate to the diatomite feed stocks are summarized in Table II.

TABLE II
Methods for Applying Sodium Aluminate to Diatomite Calcination Feed

| Ex. | Diatomite | |
|---|---|---|
| No. | % H₂O | Sodium aluminate additive dispersion, mixing with diatomite, and calcination feed preparation |
| 1 | Dry | Mill the sodium aluminate separately then disperse the milled sodium aluminate by sifting the |
| | | milled sodium aluminate through a 100 mesh screen onto the diatomite, mix by shaking or similar |
| | | type of mechanical mixing. |
| 2 | Dry | Spray a 2-9 wt % aqueous solution/slurry of sodium aluminate onto the diatomite, hand or |
| | | mechanically mix the wet diatomite/sodium aluminate mixture to consistency, dry at about 120° C., |
| | | sift the dried diatomite/sodium aluminate mixture with a sieve shaker through a 100 mesh screen. |
| 3 | 33 wt % | Mill the sodium aluminate separately then disperse the milled sodium aluminate by sifting through |
| | | a 100 mesh screen onto the diatomite, mix by shaking or similar type of mechanical mixing. Then, |
| | | spray H₂O onto and mix with the diatomite/sodium aluminate mixture until the moisture level in the |
| | | wet mixture reaches about 33 wt %, hand or mechanically mix the diatomite/sodium aluminate/H₂O |
| | | mixture to consistency, dry the diatomite/sodium aluminate/H₂O mixture at about 120° C., sift the |
| | | dried diatomite/sodium aluminate/H₂O mixture in a sieve shaker through a 100 mesh screen. |
| 4 | 33 wt % | The same as Method 3 other than that the sodium aluminate is co-milled with the diatomite in a 1:1 |
| | | ratio and the milled mixture is mixed with the remaining amount of diatomite the same way as |
| | | Method 3. |

Batch Calcination

Batch calcination may be conducted in a conventional manner. In the examples shown here, the batch calcination was carried out in either an electrical muffle furnace or an electrical rotary tube furnace with a batch size of about 40 g for about 40 min. A calcination product was dispersed by shaking through a 100 mesh screen. Other calcination methods are available, as will be apparent to those skilled in the art. And in the commercial practice, calcination is carried out continuously and in an industrial calciner such as a rotary kiln.

In the muffle furnace, the feed material was calcined in a crucible in air. With the tube furnace, the material was calcined in the middle section of a quartz tube, heated externally and rotated once every five minutes. A mixed gas of N₂/O₂/CO₂/H₂O was injected through one end of the tube at about 900 ml/min. The gas inlet end of the tube was loosely plugged with a roll of high temperature wool while the exit end was kept open.

The gas phase compositions were based on the flue gas from natural gas (assuming 100% methane) combustion in air at various levels of excess oxygen (Table III). The gas flow of each component (N₂, O₂, or CO₂) was supplied from a compressed gas cylinder and controlled by a variable area air flow meter equipped with a needle valve, with the raw flow rate reading corrected by the molecular mass of the specific gas versus air, when necessary. Water vapor for the tube furnace calcination examples was generated by running the mixed dry gas (N₂, O₂, and CO₂) through a water bath, with its temperature set to the dew point of a gas stream of the target water vapor loading (i.e., 3, 12, 16 or 23% by volume), as calculated with the Antoine equation and by taking into consideration the local barometrical pressure (Table III).

TABLE III
Gas Compositions Used for Tube Furnace Calcination Tests

| | Natural gas combustion flue gas | | |
|---|---|---|---|
| Gas | composition, % volume** | | |
| O₂ | 18 | 8 | 3 |
| N₂ | 78 | 74 | 73 |
| CO₂ | 1 | 6 | 8 |
| H₂O | 3 | 12 | 16 |
| H₂O, ° C.* | 20 | 46 | 53 |

*Dew point of the gas stream based on the Antoine equation with the barometric pressure at 645 mmHg (Reno, NV, USA).
**Assuming natural gas is 100% methane (CH₄).

Muffle Furnace Calcination

Muffle furnace calcination results are listed in Table IV. It can be seen that Examples 3-14 made with sodium aluminate (NaAlO₂.2H₂O) had much lower soluble iron contents than Examples 1-2 made with soda ash (Na₂CO₃) which had EBC soluble iron contents of about 140 ppm to about 160 ppm and ASBC soluble iron contents of about 90 ppm to about 100 ppm. In the permeability range of about 0.4 Darcy to about 1 Darcy, the EBC soluble iron contents if those made with sodium aluminate as additive fell primarily in the 40-85 ppm range and the ASBC soluble iron contents were in the 20-50 ppm range.

The process for mixing sodium aluminate with the diatomite appears to have a significant impact on soluble iron content; adding the sodium aluminate as a milled dry powder to a dried diatomite resulted in higher soluble iron content than adding the sodium aluminate in form of an aqueous solution. As seen in Table IV, when 4.8 wt % sodium aluminate was added as a milled dry powder to a dried diatomite (Example 3—using Method 1 of Table I), the EBC and ASBC soluble iron contents were 123 and 80 ppm respectively, as compared to 64 and 35 ppm when the same 4.8 wt % sodium aluminate was added in form of an aqueous solution (Example 5—using Method 2 of Table I). Without being bound by theory, it is hypothesized that the higher efficiency of iron solubility reduction of sodium aluminate being added as an aqueous solution is the result of better dispersion and distribution of the additive.

However, addition of the additive as an aqueous solution would increase the drying cost of diatomite process. Diatomite is usually mined wet, containing between 30-60% moisture and is dried prior to the calcination process. An alternative is to add a milled sodium aluminate to wet diatomite to improve its efficiency. As shown in Table V, when the dry and milled sodium aluminate was added in a way simulating addition to a wet diatomite (Example 8—using Method 3 of Table I), the iron solubilities were about at the same levels (59 and 37 ppm) as when the sodium aluminate was added as an aqueous solution (Example 5). Method 4, which includes co-milling the sodium aluminate with a small amount of diatomite then applying it to a wet feed, further improves the effectiveness (comparing Examples 8 and 11 of Table IV).

Table IV also shows specific product properties such as permeability (Darcy), wet bulk density (WBD-kg/m³), cristobalite content (wt %) and metals solubles (ppm) at varying sodium aluminate dosages and calcination temperatures. Comparing among Examples 9-14, the cristobalite content increased with increased calcination temperatures and slightly with the dosages of the sodium aluminate. Comparing among the same examples, the higher calcination temperatures and/or higher dosage of sodium aluminate, under these experimental conditions, also tend to increase the soluble iron contents as well as the permeability.

TABLE IV
Muffle Furnace Calcination with Sodium Aluminate or Soda Ash

| | Calcination Feed* | | | | | | | EBC | | ASBC |
|---|---|---|---|---|---|---|---|---|---|---|
| | NaAlO₂•2H₂O | Na₂CO₃ | Prep. | Calcine | Perm. | WBD | Cristob. | soluble, ppm | | Fe |
| Example | wt % | wt % | method** | ° C. | Darcy | kg/m³ | wt % | Al | Fe | ppm |
| 1 | | 2.0 | 1 | 1038 | 0.48 | 298 | | 42 | 141 | 93 |
| 2 | | 2.0 | 2 | 1038 | 0.69 | 293 | | 51 | 158 | 102 |
| 3 | 4.8 | | 1 | 1038 | 0.52 | 295 | | 79 | 123 | 80 |
| 4 | 2.0 | | 2 | 1093 | 0.42 | 303 | | 60 | 53 | 23 |
| 5 | 4.8 | | 2 | 1038 | 0.53 | 303 | | 52 | 64 | 35 |
| 6 | 7.0 | | 2 | 1038 | 0.74 | 330 | | 63 | 50 | 31 |
| 7 | 9.1 | | 2 | 1038 | 0.88 | 359 | | 111 | 52 | 4 |
| 8 | 4.8 | | 3 | 1038 | 0.84 | 282 | | 46 | 59 | 37 |
| 9 | 6.8 | | 4 | 982 | 0.90 | 295 | 3 | 99 | 63 | 44 |
| 10 | 2.4 | | 4 | 1038 | 0.72 | 264 | 11 | 69 | 45 | 16 |
| 11 | 4.7 | | 4 | 1038 | 0.82 | 298 | 10 | 50 | 53 | 30 |
| 12 | 6.8 | | 4 | 1038 | 0.88 | 343 | 14 | 62 | 51 | 31 |
| 13 | 2.4 | | 4 | 1093 | 0.81 | 283 | 44 | 83 | 56 | 29 |
| 14 | 4.7 | | 4 | 1093 | 0.96 | 316 | 49 | 75 | 78 | 42 |

*Diatomite A (Table I).
**Refer to Table II for feed preparation methods.

Tube Furnace Calcination

Tube furnace calcination data are listed in Tables V (calcination with sodium aluminate) and VI (calcination with soda ash). The lower soluble iron contents that resulted from using sodium aluminate in the muffle furnace calcination were largely reproduced in the tube furnace calcination; comparing the EBC soluble iron content range of 50-84 and the ASBC soluble iron content range of 25-47 ppm of Table V (calcination with sodium aluminate) versus the 168-177 and 110-123 ppm ranges of Table VI (calcination with soda ash).

Using 2 wt % sodium aluminate, calcining at 1038° C. and simulating the natural gas combustion flue gas (Examples 15-17, Table V), varying the oxygen had a small effect on various properties of the products. Reduced oxygen in the gas phase appeared to increase product permeability but reduced cristobalite as well as the soluble iron contents. The subsequent testing was conducted with an 8% oxygen content.

TABLE V
Tube Furnace Calcination with Sodium Aluminate*

| | | | | | | | | | EBC | | |
|---|---|---|---|---|---|---|---|---|---|---|---|
| | | Gas Phase, | | | | | | | Solubles, | | |
| | NaAlO₂•2H₂O | % volume** | | | Calcine | Perm. | WBD | Cristob. | ppm | | ASBC |
| Example | wt % | O₂ | CO₂ | H₂O | ° C. | Darcy | kg/m³ | wt % | Al | Fe | Fe, ppm |

Feed preparation Method 4 - sodium aluminate co-milled with diatomite in a 1:1 ratio

| | | | | | | | | | | | |
|---|---|---|---|---|---|---|---|---|---|---|---|
| 15 | 2 | 18 | 1 | 3 | 1038 | 0.65 | 267 | 13 | 71 | 61 | 29 |
| 16 | 2 | 8 | 6 | 12 | 1038 | 0.71 | 263 | 12 | 59 | 59 | 28 |
| 17 | 2 | 3 | 8 | 16 | 1038 | 0.74 | 272 | 8 | 47 | 54 | 25 |
| 18 | 4 | 8 | 6 | 12 | 1038 | 0.67 | 303 | 19 | 63 | 81 | 40 |
| 19 | 4 | 8 | 6 | 12 | 1038 | 0.86 | 266 | 13 | 55 | 76 | 38 |
| 20 | 6 | 8 | 6 | 12 | 1038 | 1.00 | 298 | 24 | 63 | 84 | 45 |
| 21 | 8 | 8 | 6 | 12 | 1038 | 0.99 | 356 | 55 | 105 | 70 | 47 |
| 22 | 10 | 8 | 6 | 12 | 1038 | 0.96 | 391 | 52 | 324 | 55 | 39 |
| 23 | 8 | 8 | 6 | 12 | 982 | 0.98 | 314 | 15 | 85 | 50 | 30 |
| 24 | 10 | 8 | 6 | 12 | 982 | 1.21 | 328 | 32 | 197 | 58 | 40 |
| 25 | 8 | 8 | 6 | 12 | 927 | 1.07 | 258 | 2 | 297 | 62 | 43 |
| 26 | 10 | 8 | 6 | 12 | 927 | 1.19 | 296 | 6 | 580 | 49 | 26 |

*Diatomite feed stocks A and B (Table I).
**The balance as N₂, the same below.

TABLE VI
Tube Furnace Calcination with Soda Ash*

| | | | | | | | | | EBC | | |
|---|---|---|---|---|---|---|---|---|---|---|---|
| | Soda | Gas Phase, | | | | | | | Solubles, | | |
| | Ash | % volume | | | Calcine | Perm. | WBD | Cristob. | ppm | | ASBC |
| Example | wt % | O₂ | CO₂ | H₂O | ° C. | Darcy | kg/m³ | wt % | Al | Fe | Fe, ppm |
| 27 | 2.0 | 8 | 6 | 12 | 1038 | 1.45 | 245 | 58 | 34 | 177 | 110 |
| 28 | 3.0 | 8 | 6 | 12 | 982 | 0.51 | 287 | 54 | 28 | 168 | 123 |

*Diatomite feed stocks A and B (Table I) soda ash sifted through a 325 mesh screen and mixed with diatomite dry.

Sodium Aluminate-Soda Ash Hybrid Additive

Examples 29-32 of Table VII are designed to evaluate the impact of adding a small amount of soda ash to an 8 wt % sodium aluminate/diatomite mixture. The sodium aluminate was added to wet diatomite ore according to Method 4 in Table II, the mixture was dried and the soda ash was added to the dried mixture. The test results are listed in Table VII. Adding up to 3 wt % soda ash not only increased product permeability from 0.93 to 1.66 Darcy at the same time the EBC and ASBC soluble iron contents were maintain in the range of 65 to 75 and 33 to 46 ppm, respectively.

TABLE VII
Tube Furnace Calcination with Sodium Aluminate and Soda Ash*

| | | | | | | EBC | | |
|---|---|---|---|---|---|---|---|---|
| | | Soda Ash | Calcine | Perm. | WBD | Solubles, ppm | | ASBC |
| Example | NaAlO₂•2H₂O, wt % | wt % | ° C. | Darcy | kg/m³ | Al | Fe | Fe, ppm |
| 29 | 8.0 | 0.0 | 982 | 0.93 | 341 | 115 | 67 | 40 |
| 30 | 8.0 | 1.0 | 982 | 1.08 | 338 | 509 | 72 | 46 |
| 31 | 8.0 | 2.0 | 927 | 1.25 | 320 | 767 | 75 | 40 |
| 32 | 8.0 | 3.0 | 927 | 1.66 | 317 | 753 | 65 | 33 |

*Diatomite feed C (Table I); 8% O₂, 6% CO₂ and 12% H₂O by volume in the gas phase; sodium aluminate added to wet feed (Method 4-Table II) and soda ash added to the dried mix.

### INDUSTRIAL APPLICABILITY

A new process has been developed to make medium flow rate diatomaceous earth filter aids. In this development, an alkali metal aluminate, e.g., sodium aluminate (NaAlO₂.xH₂O), is used as an additive/flux agent. As compared to either straight calcined or soda ash (Na₂CO₃)-flux calcined products of similar permeability, the new products have much lower iron solubility. For example, products of 0.3-1.5 Darcy using an alkali metal aluminate without soda ash are disclosed with about 40-85 ppm EBC soluble iron content versus greater than 150 ppm EBC soluble iron content for equivalent processes that use soda ash as the additive/flux agent. In conclusion, disclosed examples can be used to make medium grade diatomaceous earth filter aids of low iron solubility in the range of about 0.3 Darcy to about 2.0 Darcy.

What is claimed is:

1. A diatomite filter aid comprising:
at least one alkali aluminate;
a European Brewing Convention (EBC) soluble iron content of less than about 100 ppm or American Society of Brewing Chemist (ASBC) soluble iron content of less than about 50 ppm;
a cristobalite content exceeding 1 wt %; and
wherein the filter aid has a permeability ranging from about 0.3 Darcy to about 2 Darcy.

2. The diatomite filter aid of claim 1, wherein the EBC soluble iron content is less than about 70 ppm.

3. The diatomite filter aid of claim 1, wherein the EBC soluble iron content is less than about 50 ppm.

4. The diatomite filter aid of claim 1, wherein the ASBC soluble iron content is less than about 35 ppm.

5. The diatomite filter aid of claim 1, wherein the ASBC soluble iron content is less than about 25 ppm.

6. The calcined diatomite filter aid of claim 1, wherein the filter aid has a permeability ranging from about 0.5 Darcy to about 1.5 Darcy.

7. The calcined diatomite filter aid of claim 1, wherein a cristobalite content of the filter aid is greater than about 2%.

8. A method for preparing a diatomite filter aid product comprising:
mixing at least one alkali metal aluminate with diatomite to form a mixture; and
calcining the mixture at a temperature ranging from 900° C. to about 1300° C. to produce the diatomite filter aid product having an EBC soluble iron content of less than about 100 ppm or an ASBC soluble iron content of less than about 50 ppm.

9. The method of claim 8, wherein the EBC soluble iron content of the calcined diatomite filter aid product is less than about 70 ppm.

10. The method of claim 8, wherein the EBC soluble iron content of the calcined diatomite filter aid product is less than about 50 ppm.

11. The method of claim 8, wherein the ASBC soluble iron content of the calcined diatomite filter aid product is less than about 35 ppm.

12. The method of claim 8, wherein the ASBC soluble iron content of the calcined diatomite filter aid product is less than about 25 ppm.

13. The method of claim 8, wherein the diatomite filter aid product has a permeability ranging from about 0.3 Darcy to about 2 Darcy.

14. The method of claim 8, wherein the at least one alkali metal aluminate is sodium aluminate.

15. The method of claim 8, wherein the at least one alkali metal aluminate is selected from the group consisting of lithium aluminate, sodium aluminate, potassium aluminate and combinations thereof.

16. The method of claim 8, wherein the mixture has an alkali metal aluminate content as on the dried and anhydrous basis in an amount ranging from about 0.1 to about 10 wt %.

17. The method of claim 8, wherein the mixture has an alkali metal aluminate content as on the dried and anhydrous basis in an amount ranging from about 2 to about 8 wt %.

18. The method of claim 8, wherein the mixture includes a diatomite fluxing agent selected from the group consisting of an alkali metal carbonate, halide, and combinations thereof.

19. The method of claim 8, wherein the mixture includes water.

20. A method for preparing a calcination feed mixture of diatomite and at least one alkali metal aluminate for use in making a diatomite filter aid having a low soluble iron content, the method comprising:
mixing the at least one alkali metal aluminate with diatomite to form a first mixture; and
forming a calcination feed from the first mixture,
wherein the diatomite filter aid has an EBC soluble iron content of less than about 100 ppm or an ASBC soluble iron content of less than about 50 ppm.

21. The method of claim 20, further including drying the first mixture before the forming, wherein the at least one alkali metal aluminate is an aqueous solution.

22. The method of claim 21, wherein the aqueous solution of the at least one alkali metal aluminate is produced by dissolving a solid of the at least one alkali metal aluminate in water.

23. The method of claim 20, further including:
fine milling of the at least one alkali metal aluminate, wherein the at least one alkali metal aluminate is solid and the diatomite is dry diatomite.

24. The method of claim 20, further including:
fine milling of the at least one alkali metal aluminate; and
drying the first mixture before the forming,
wherein the at least one alkali metal aluminate is solid and the diatomite is wet diatomite.

25. The method of claim 24, wherein the wet diatomite is a wet diatomite ore before drying.

26. The method of claim 20, further including
co-milling of the alkali metal aluminate with a dispersion material before the mixing,
wherein the at least one alkali metal aluminate is solid and the alkali metal aluminate of the mixing is the result of the co-milling.

27. The method of claim 26, further including:
drying the first mixture, wherein the diatomite is wet diatomite.
